(19) United States
(12) Patent Application Publication
(10) Pub. No.: US 2017/0237592 A1
(43) Pub. Date: Aug. 17, 2017

(54) PEAK TO AVERAGE POWER RATIO REDUCTION IN ELAA

(71) Applicant: MEDIATEK INC., Hsinchu (TW)

(72) Inventors: Weidong Yang, San Diego, CA (US); Chien-Chang Li, Penghu County (TW); Bo-Si Chen, Keelung City (TW)

(21) Appl. No.: 15/423,999

(22) Filed: Feb. 3, 2017

Related U.S. Application Data
(60) Provisional application No. 62/291,585, filed on Feb. 5, 2016.
(60) Provisional application No. 62/296,148, filed on Feb. 17, 2016.

(51) Int. Cl. H04L 27/26; H04J 11/00; H04B 7/06; H04W 16/14; H04W 72/04

(52) U.S. Cl. CPC H04L 27/262; H04W 16/14; H04W 72/0453; H04B 7/0639; H04W 72/0413; H04J 11/00; H04J 2211/008

(57) ABSTRACT

A method of uplink transmission to reduce peak-to-average power ratio (PAPR) in enhanced licensed assisted access (eLAA) is proposed. New design of Physical Uplink Control Channel (PUCCH) and Physical Uplink Shared Channel (PUSCH) is proposed. Across frequency domain of the channel bandwidth, multiple resource interlaces are allocated for different UEs for uplink PUCCH/PUSCH transmission to satisfy the occupied channel bandwidth requirement for unlicensed carrier access. In addition, uplink transmission with co-phasing terms are applied to reduce PAPR of the resulted waveform.

### CROSS REFERENCE TO RELATED APPLICATIONS

This application claims priority under 35 U.S.C. §119 from U.S. Provisional Application No. 62/291,585, entitled “The Method of PAPR Reduction in eLAA,” filed on Feb. 5, 2016; U.S. Provisional Application No. 62/296,148, entitled “The Method of PAPR Reduction in eLAA,” filed on Feb. 17, 2016, the subject matter of which is incorporated herein by reference.

### TECHNICAL FIELD

The disclosed embodiments relate generally to wireless network communications, and, more particularly, to peak to average power ratio (PAPR) reduction in licensed assisted access (LAA) wireless communications systems.

### BACKGROUND

Third generation partnership project (3GPP) and Long Term Evolution (LTE) mobile telecommunication systems provide high data rate, lower latency and improved system performances. With the rapid development of “Internet of Things” (IOT) and other new user equipment (UE), the demand for supporting machine communications increases exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In such a solution, an established communication protocol such as Long Term Evolution (LTE) can be used over the licensed spectrum to provide a first communication link, and LTE can also be used over the unlicensed spectrum to provide a second communication link.

Furthermore, while LAA only utilizes the unlicensed spectrum to boost downlink through a process of carrier aggregation, enhanced LAA (eLAA) allows uplink streams to take advantage of the 5 GHz unlicensed band as well. Although eLAA is straightforward in theory, practical usage of eLAA while complying with various government regulations regarding the usage of unlicensed spectrum is not so straightforward. Moreover, maintaining reliable communication over a secondary unlicensed link requires improved techniques.

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data.

In some countries, there are requirements on the occupied channel bandwidth for unlicensed carrier access. Specifically, the occupied channel bandwidth shall be between 80% and 100% of the declared nominal channel bandwidth. During an established communication, a device is allowed to operate temporarily in a mode where its occupied channel bandwidth may be reduced to as low as 40% of is nominal channel bandwidth with a minimum of 4 MHz. The occupied bandwidth is defined as the bandwidth containing 99% of the power of the signal. The nominal channel bandwidth is the widest band of frequencies inclusive of guard bands assigned to a single carrier (at least 5 MHz).

A design of PUSCH/PUCCH to satisfy the requirements on the occupied channel bandwidth in eLAA wireless communications network is sought.

### SUMMARY

A method of uplink transmission to reduce peak-to-average power ratio (PAPR) in enhanced licensed assisted access (eLAA) is proposed. New design of Physical Uplink Control Channel (PUCCH) and Physical Uplink Shared Channel (PUSCH) is proposed. Across frequency domain of the channel bandwidth, multiple resource interlaces are allocated for different UEs for uplink PUCCH/PUSCH transmission to satisfy the occupied channel bandwidth requirement for unlicensed carrier access. In addition, uplink transmission with co-phasing terms are applied to reduce PAPR of the resulted waveform.

In one embodiment, a user equipment (UE) obtains a set of resource blocks for an uplink channel in an orthogonal frequency division multiplexing (OFDM) wireless communications network. The set of resource blocks is distributed along frequency domain to occupy a predefined percentage of an entire channel bandwidth. The UE applies a co-phasing vector comprising a set of co-phasing terms, wherein each co-phasing term of the co-phasing vector is applied to a corresponding resource block of the set of resource blocks. The UE transmits a radio signal containing uplink information over the uplink channel applied with the co-phasing vector.

In another embodiment, a base station allocates a first set of resource blocks to a first user equipment (UE) in an orthogonal frequency division multiplexing (OFDM) wireless communications network. The base station allocates a second set of resource blocks to a second UE. The first and the second sets of resource blocks comprise interleaved PRBs forming interlaces along frequency domain. Each interlace occupies a predefined percentage of an entire channel bandwidth. The base station simultaneously schedules the first UE and the second UE for uplink transmission over the first set of resource blocks and the second set of resource blocks respectively.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system with modified PUCCH/PUSCH and PAPR reduction in accordance with a novel aspect.

FIG. 2 is a simplified block diagram of a wireless transmitting device and a receiving device in accordance with a novel aspect.

FIG. 3 illustrates one example of PUCCH design to satisfy the occupied channel bandwidth requirements.

FIG. 4 illustrates one example of PUCCH design with PUCCH format 4 to satisfy the occupied channel bandwidth requirements.

FIG. 5 illustrates another example of PUCCH design with PUCCH format 4 to satisfy the occupied channel bandwidth requirements.

FIG. 6 illustrates one example of interlaced PUSCH design to satisfy the occupied channel bandwidth requirements.

FIG. 7 illustrates one embodiment of uplink scheduling handling the block issue.

FIG. 8 illustrates one embodiment of uplink scheduling with SRS transmission.

FIG. 9 illustrates one embodiment of applying co-phasing vector for uplink transmission over PUCCH or PUSCH for PAPR reduction.

FIG. 10 illustrates one example of co-phasing vector using DBMS coefficients.

FIG. 11 is flow chart of a method of uplink transmission over PUCCH/PUSCH with PAPR reduction in accordance with one novel aspect.

FIG. 12 is a flow chart of a method of uplink scheduling for PUCCH/PUSCH from base station perspective in accordance with one novel aspect.

### DETAILED DESCRIPTION

Reference will now be made in detail to some embodiments of the invention, examples of which are illustrated in the accompanying drawings.

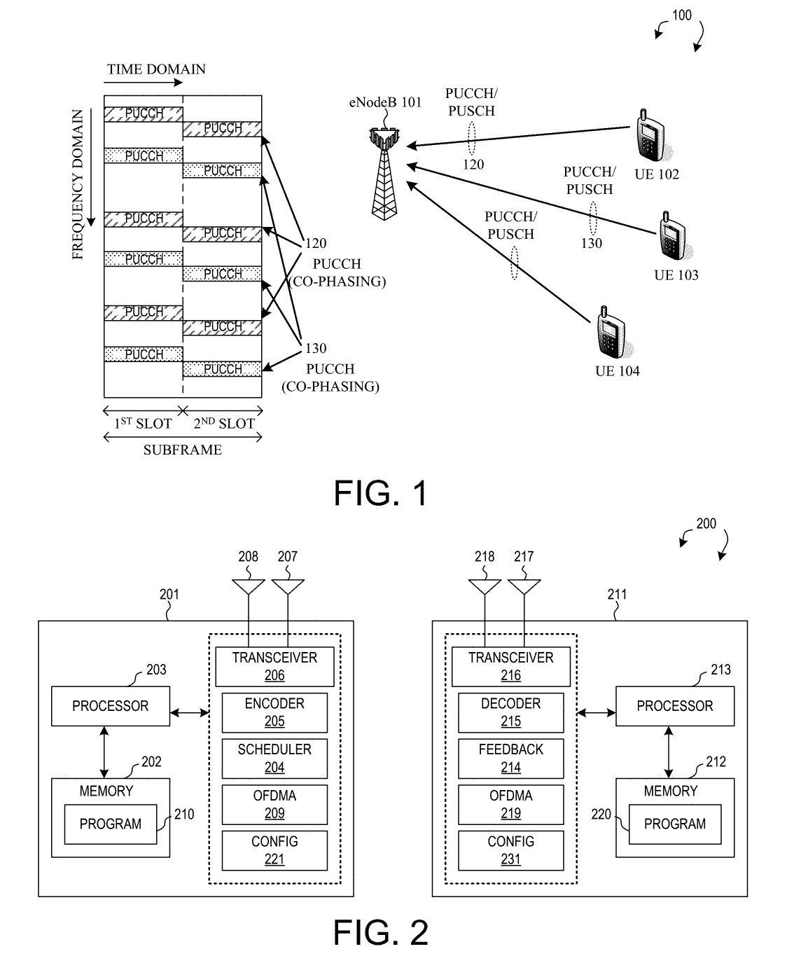

FIG. 1 illustrates a wireless communications system with PUCCH/PUSCH design and PAPR reduction in accordance with a novel aspect. Mobile communication network 100 is an OFDM/OFDMA system comprising a base station eNodeB 101 and a plurality of user equipment UE 102, UE 103, and UE 104. In 3GPP LTE system based on OFDMA downlink, the radio resource is partitioned into subframes in time domain, each subframe is comprised of two slots. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. REs are grouped into physical resource blocks (PRBs), where each PRB consists of 12 consecutive subcarriers in one slot.

When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI). The uplink control information (UCI) including HARQ ACK/NACK, CQI, MIMO feedback, scheduling requests is carried by a physical uplink control channel (PUCCH) or PUSCH if the UE has data or RRC signaling.

Licensed Assisted Access (LAA) has been proposed to meet the exponential increase in communication demand. In LAA, a combination of licensed spectrum and unlicensed spectrum is used. An established communication protocol such as Long Term Evolution (LTE) can be used over the licensed spectrum to provide a first communication link, and LTE can also be used over the unlicensed spectrum to provide a second communication link. Furthermore, while LAA only utilizes the unlicensed spectrum to boost downlink through a process of carrier aggregation, enhanced LAA (eLAA) allows uplink streams to take advantage of the 5 GHz unlicensed band as well. For unlicensed carrier access, however, there are requirements on the occupied channel bandwidth in some countries. Specifically, the occupied channel bandwidth shall be between 80% and 100% of the declared nominal channel bandwidth. As a result, the legacy PUCCH and PUSCH designs in LTE may not meet such requirements.

In the example of FIG. 1, PUCCH 120 is allocated for UE 102 for uplink control information. The radio resources for PUCCH 120 need to be spread across the frequency domain to satisfy the requirements on the occupied channel bandwidth. PUCCH 130 is allocated for UE 103 for uplink control information. The radio resources for PUCCH 130 also need to be spread across the frequency domain to satisfy the requirements on the occupied channel bandwidth. PUCCH 120 and PUCCH 130 form different resource interlace across the entire frequency domain. Similarly, for PUSCH, if eNodeB 101 schedules a number of UEs in a subframe, then it may not be able to ensure each UE's transmission meets the occupied bandwidth requirement. The radio resources for PUSCH for each UE thus also need to be spread across the frequency domain. For example, a number of resource interlaces over the nominal channel bandwidth with interleaved PRBs may be allocated as PUSCHs to the number of UEs.

The transmit signals in an OFDM system can have high peak values in the time domain since many subcarrier components are added via an Inverse Fast Fourier Transformation (IFFT) operation. As a result, OFDM system are known to have a high peak-to-average power ratio (PAPR) when compared to single-carrier systems. Furthermore, the requirements on the occupied channel bandwidth in LAA result in even higher PAPR since the legacy PUCCH and PUSCH are replicated in the resource interlace across the entire frequency domain. In accordance with one novel aspect, a co-phasing vector is applied to the replicates on different PRBs to reduce the PAPR.

FIG. 2 is a simplified block diagram of wireless devices 201 and 211 in accordance with a novel aspect. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a transmitting device that includes an encoder 205, a scheduler 204, an OFDMA module 209, and a configuration circuit 221. Wireless device 211 is a receiving device that includes a decoder 215, a feedback circuit 214, a OFDMA module 219, and a configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the transmitting device (a base station) configures radio resource (PUCCH/PUSCH) for UEs via configuration circuit 221, schedules downlink and uplink transmission for UEs via scheduler 204, encodes data packets to be transmitted via encoder 205 and transmits OFDM radio signals via OFDM module 209. The receiving device (a user equipment) obtains allocated radio resources for PUCCH/PUSCH via configuration circuit 231, receives and decodes downlink data packets via decoder 215, and transmits uplink information over the PUCCH/PUSCH applied with co-phasing vector to reduce PAPR of the radio signal via OFDM module 219.

For PUCCH format 1/1a/1a, 2/2a/2b, 3, and 5, the occupied resource in frequency domain is only one PRB and thus the requirement on the occupied channel bandwidth is not satisfied. For PUCCH format 4, there can be more than one resource blocks per PUCCH. PUCCH format 4 contains M_{RB}^{PUCCH4} consecutive PRBs in frequency domain, wherein M_{RB}^{PUCCH4}=1,2,3,4,5,6,8. Since the resource blocks of PUCCH format 4 are contiguous and thus the requirements on the occupied channel bandwidth may not be satisfied as well. For convenience, the resource allocation for PUCCH format 4 is shown below, where nₛ is slot index. There is a shift between slot 0 and slot 1.

$${n}_{PRB} = \{ \begin{matrix}m & if {n}_{s} mod 2 = 0 \\ {N}_{RB}^{UL} - 1 - m & if {n}_{s} mod 2 = 1\end{matrix} \\ m = {n}_{PUCCH}^{( 4 )} , {n}_{PUCCH}^{( 4 )} + 1 , … , {n}_{PUCCH}^{( 4 )} + {M}_{RB}^{PUCCH 4} - 1$$

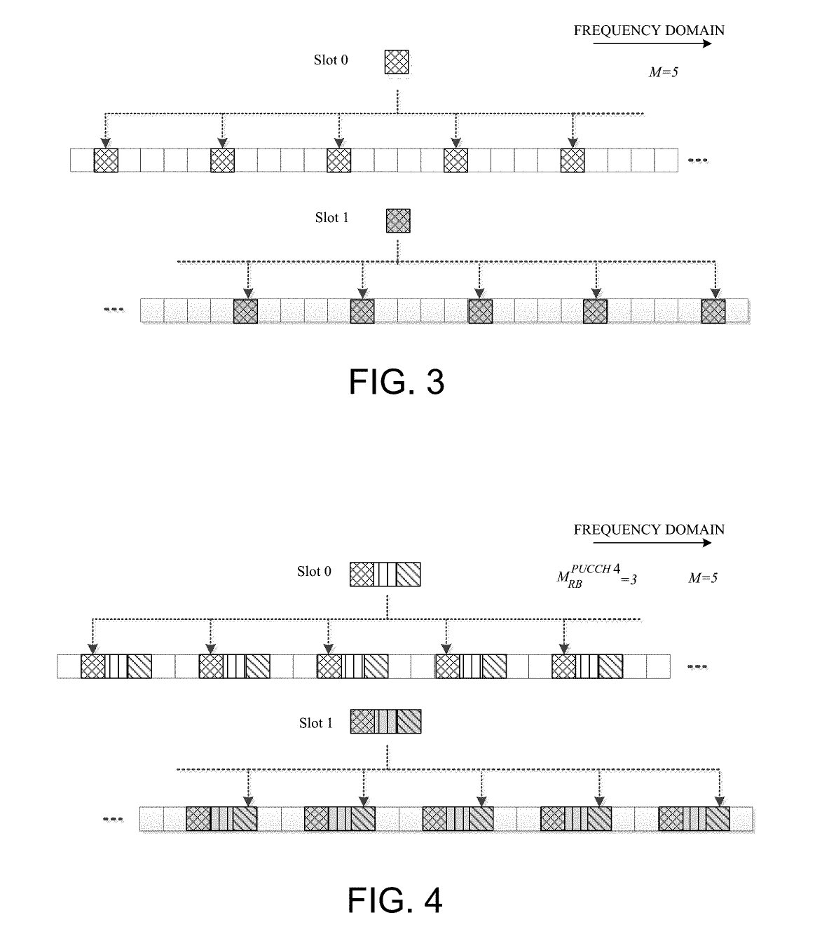

FIG. 3 illustrates one example of PUCCH design to satisfy the occupied channel bandwidth requirements. For PUCCH format 1/1a/1a, 2/2a/2b, 3, and 5, spreading the PUCCH resource in the frequency domain can be considered to satisfy the requirements on the occupied channel bandwidth. For example, the PUCCH resources can be repeated every M RBs. As shown in FIG. 3, M=5 and the index of occupied PUCCH PRBs is {1, 56, 11, . . . , 96}.

FIG. 4 illustrates one example of PUCCH design with PUCCH format 4 to satisfy the occupied channel bandwidth requirements. For PUCCH format 4, two alternatives can be considered to satisfy the requirements on the occupied channel bandwidth. In the example of FIG. 4, the PUCCH resources can be block-spread in frequency domain. For example, the PUCCH resources are repeated every M RBs. As shown in FIG. 4, M_{RB}^{PUCCH4}=3 and M=5. The three consecutive PRBs of PUCCH format 4 are spread in frequency domain by being replicated every five PRBs. The index of occupied PRBs is {1, 2, 3, 6, 7, 8, 11, 12, 13, . . . , 96, 97, 98}.

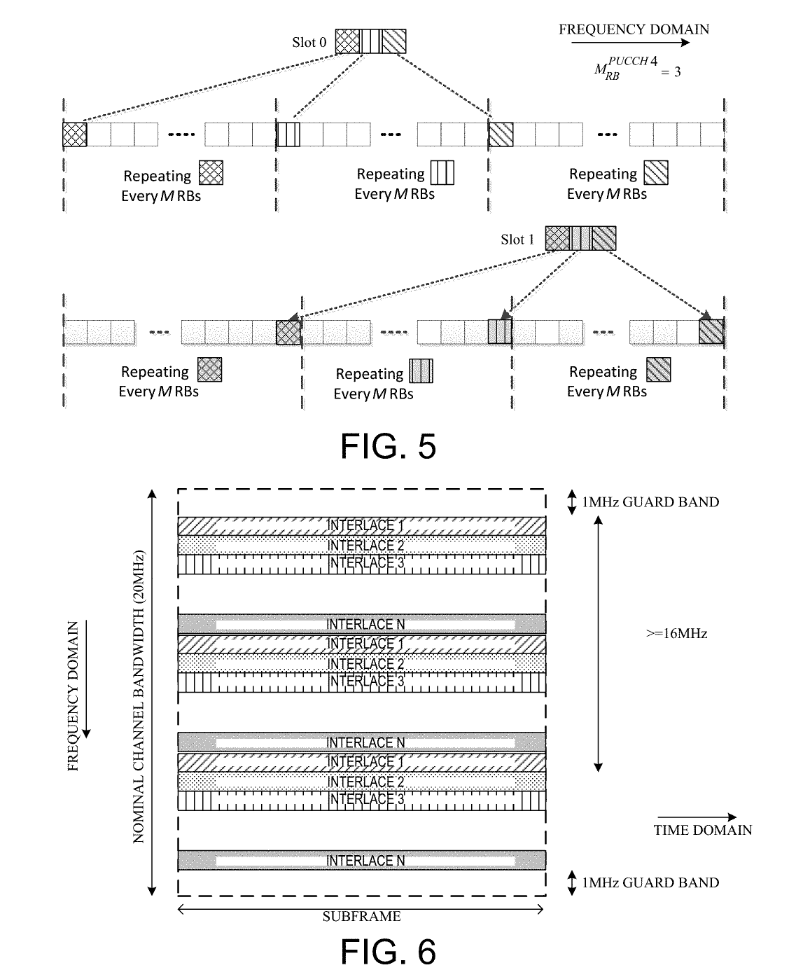

FIG. 5 illustrates another example of PUCCH design with PUCCH format 4 to satisfy the occupied channel bandwidth requirements. In FIG. 5, the resource of PUCCH is first uniformly allocated in the whole bandwidth. Then each PUCCH PRB is spread in the corresponding sub-block or region. For example, in FIG. 5, the three consecutive PRBs of PUCCH format 4 are spread in frequency domain by two steps. In a first step, the three PRBs are spread uniformly in frequency domain, which divides the frequency domain into three regions. In a second step, in each region, each PUCCH PRB is repeated every M RBs in the corresponding sub-block/region.

In LTE, frequency hopping such as the mirror mapping in intra-subframe frequency hopping can be used to meet the occupied channel bandwidth requirements for a few UEs. From Rel-10, two cluster allocation is also available. Two cluster allocation can be also used to meet the occupied channel bandwidth requirements for a few UEs. However, if eNB needs to schedule a number of UEs in a subframe, then it may not be able to ensure each UE's transmission meets the occupied bandwidth requirements. One possibility is that only a limited number of UEs can be scheduled in a subframe in a region where there are occupied channel bandwidth requirements, and it is up to eNB scheduling to ensure the requirements are met.

FIG. 6 illustrates one example of interlaced PUSCH design to satisfy the occupied channel bandwidth requirements. Using a 20 MHz channel as an example, from the requirement that at 80% occupied bandwidth is required, the frequency interval between the first PRB and the last PRB in an interlace is at least 16 MHz. As depicted in FIG. 6, each resource interlace has the same number of resource units, each resource unit is shown as rectangular block and resource units for one resource interlace are in the same shade. The bandwidth of (N−1) resource units <=2 MHz. One resource interlace is the minimum a UE can be granted with. Hence N is also the number of UEs which can be simultaneously scheduled in one subframe. Assume a resource unit is one PRB, then 2 MHz/180 KHz=11, further N needs to be a factor of 100, the number of PRBs in a subframe, N can be chosen as 10. Assume one or more resource interlaces can be granted to UE, and consider the FFT size for the DFT spreading can have only 2, 3 and 5 as its factors; one UE can be granted with 10, 20, 30, 40, 50, 60, 80, 90 or 100 PRBs in one subframe. Depending on the traffic going through eLAA uplink, the granularity of resource grant may or may not be fine enough. In the event that it is found that a finer granularity becomes necessary, one solution is to use a smaller resource unit, e.g. 6 tones for one resource unit, whereby N=20 can be obtained and one resource interlace consists of 60 tones. Note that along with PUSCH, one or more resource interlace can also be used in PUCCH.

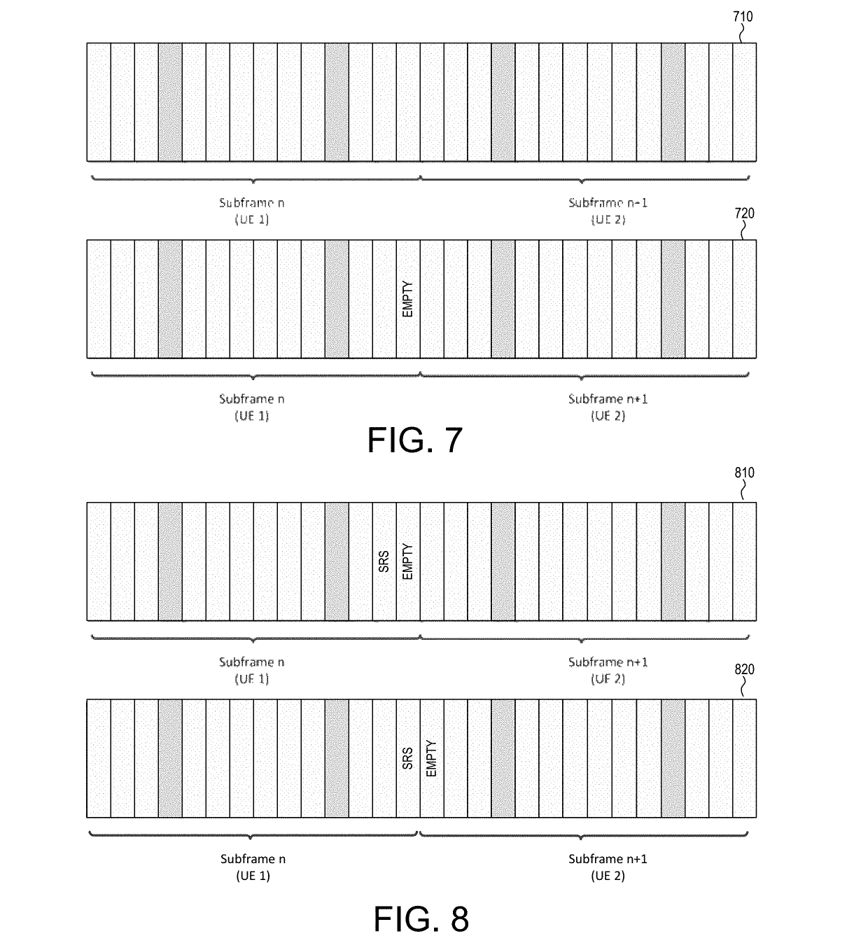

FIG. 7 illustrates one embodiment of uplink scheduling handling the block issue. When eNB schedules two subframes back-to-back to different UEs, the uplink transmission from UE 1 may block the transmission from UE 2 as shown in top diagram 710 of FIG. 7. To avoid that, UE 1 can drop the last symbol in subframe n so to create clear channel assessment (CCA) opportunities for UE 2 scheduled to transmit in subframe n+1 as shown in bottom diagram 720 of FIG. 7.

FIG. 8 illustrates one embodiment of uplink scheduling with sounding reference signal (SRS) transmission. When aperiodic SRS is transmitted along with PUSCH, SRS can still occupy the last symbol in a UE's uplink transmission. When wideband SRS is transmitted, it does not need to use the resource interlace to spread the signal over the whole channel. In another word, spreading over the whole channel through resource interlace is used for PUSCH/PUCCH, but not for SRS. If SRS is requested for UE 1 in subframe n, then a further modification is needed as shown in top diagram 810 of FIG. 8. It is also possible to create the empty symbol at the beginning of subframe n+1 instead of subframe n. The eNB can signal that in the downlink control, e.g. inside a common PDCCH or a PDCCH dedicated to a UE. With the signaling from eNB, a UE scheduled to transmit in subframe n+1 knows the CCA opportunities (empty symbol) are according to top diagram 810 of FIG. 8 (last OFDM symbol in subframe n) or according to bottom diagram 820 of FIG. 8 (first OFDM symbol in subframe n+1).

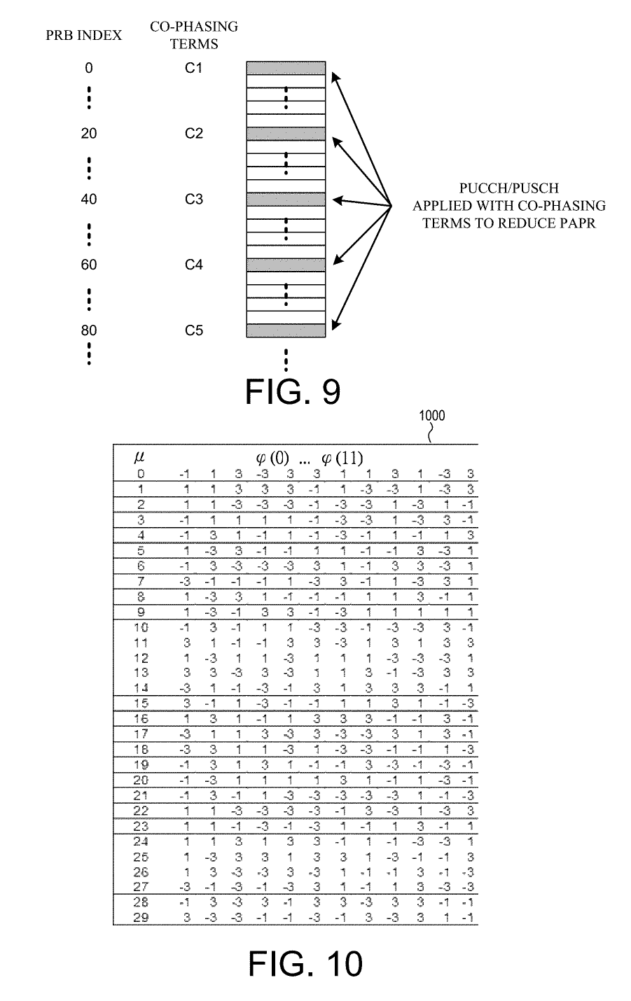

FIG. 9 illustrates one embodiment of applying co-phasing vector for uplink transmission over PUCCH or PUSCH for PAPR reduction. Assume that PUCCH or PUSCH is mapped to one resource interlace, e.g., replicating the legacy PUCCH at all the PRBs in one resource interlace, then the PAPR of the resulted waveform can be very high. For example, assume PUCCH format 2 is replicated over 10 PRBs (e.g., taking one resource interlace (PRBs 1, 11, 21, . . . , 91) out of 100 PRBs in a 20 MHz system), then PAPR can be very high. In accordance with one novel aspect, co-phasing terms are applied to reduce PAPR.

In the example of FIG. 9, suppose the PUCCH occupies one PRB, i.e., the PUCCH signal is r_{k,l}, where 0<=k<=11 is the subcarrier index, and 0<=l<=6 is the OFDM symbol index for slot 0. In slot 0, the PUCCH is repeated in 0^{th}, 20^{th}, 40^{th}, 60^{th}, and 80^{th} PRB. The replicated signals can be represented as:
For 0-th RB, y0_{k,l}=r_{k,l},
For 20-th RB, y1_{k+12*20,l}=r_{k,l},
For 40-th RB, y2_{k+12*40,l}=r_{k,l},
For 60-th RB, y3_{k+12*60,l}=r_{k,l},
For 80-th RB, y4_{k+12*80,l}=r_{k,l},

Since there are 5 repetitions, we need 5 co-phasing terms c0, c1, c2, c3, and c4. Then the resulted signals after co-phasing become:
Z0=y0*C0
Z1=y0*C1
Z2=y0*C2
Z3=y0*C3
Z4=y0*C4

In slot 1, the same procedure is applied. It has been shown that some co-phasing terms applied to the replicates on different PRBs can lead to a lower PAPR in the resulted wave form.

FIG. 10 illustrates one example of co-phasing vector using DBMS coefficients. Specifically, it is found that truncated DMRS coefficients provide good PAPR reduction as compared to the simple replication scheme. For example, in the simple replication scheme, the co-phasing vector is [1,1,1,1,1,1,1,1,1,1] for 10 PRB repetitions, as all the co-phasing terms are equal to one. On the other hand, the base sequence for DMRS coefficients is given by:

r(n)=e^{jφ(n)Å/4}
where the value of φ(n) is given by table 1000 in FIG. 10.

For 10 repetitions, in the length-12 DMRS coefficients, elements 1-10, 2-11, or 3-12 are selected as the length-10 co-phasing terms as there are 10 PRBs in a resource interlace. Note there are a total of 30 different sets of DMRS coefficients with different μ values. The different sets of DMRS coefficients can be selected by different cells to be applied to different UEs as the co-phasing terms.

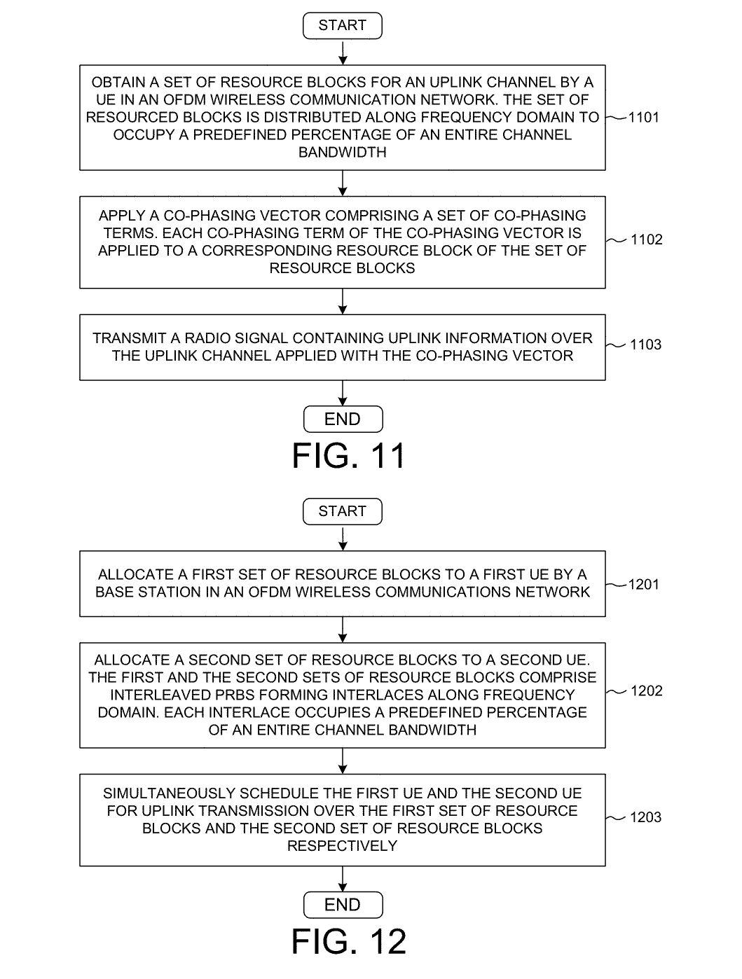

FIG. 11 is flow chart of a method of uplink transmission over PUCCH/PUSCH with PAPR reduction in accordance with one novel aspect. In step 1101, a user equipment (UE) obtains a set of resource blocks for an uplink channel in an orthogonal frequency division multiplexing (OFDM) wireless communications network. The set of resource blocks is distributed along frequency domain to occupy a predefined percentage of an entire channel bandwidth. In step 1102, the UE applies a co-phasing vector comprising a set of co-phasing terms, wherein each co-phasing term of the co-phasing vector is applied to a corresponding resource block of the set of resource blocks. In step 1103, the UE transmits a radio signal containing uplink information over the uplink channel applied with the co-phasing vector.

FIG. 12 is a flow chart of a method of uplink scheduling for PUCCH/PUSCH from base station perspective in accordance with one novel aspect. In step 1201, a base station allocates a first set of resource blocks to a first user equipment (UE) in an orthogonal frequency division multiplexing (OFDM) wireless communications network. In step 1202, the base station allocates a second set of resource blocks to a second UE. The first and the second sets of resource blocks comprise interleaved PRBs forming interlaces along frequency domain. Each interlace occupies a predefined percentage of an entire channel bandwidth. In step 1203, the base station simultaneously schedules the first UE and the second UE for uplink transmission over the first set of resource blocks and the second set of resource blocks respectively.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
obtaining a set of resource blocks for an uplink channel by a user equipment (UE) in an orthogonal frequency division multiplexing (OFDM) wireless communications network, wherein the set of resource blocks is distributed along frequency domain to occupy a predefined percentage of an entire channel bandwidth;
applying a co-phasing vector comprising a set of co-phasing terms, wherein each co-phasing term of the co-phasing vector is applied to a corresponding resource block of the set of resource blocks; and
transmitting a radio signal containing uplink information over the uplink channel applied with the co-phasing vector.

2. The method of claim 1, wherein the uplink channel is a Physical Uplink Control Channel (PUCCH), wherein the set of resource blocks comprises one physical resource block (PRB) repeated every M PRBs along frequency domain.

3. The method of claim 1, wherein the uplink channel is a Physical Uplink Control Channel (PUCCH), wherein the set of resource blocks comprises a number of consecutive physical resource blocks (PRBs) spread along frequency domain.

4. The method of claim 1, wherein the uplink channel is a Physical Uplink Control Channel (PUCCH), wherein the set of resource blocks is uniformly allocated in the entire bandwidth, and wherein each physical resource block (PRB) is spread along frequency domain.

5. The method of claim 1, wherein the uplink channel is a Physical Uplink Shared Channel (PUSCH), and wherein the PUSCH resources comprises interleaved physical resource blocks (PRBs).

6. The method of claim 1, wherein the co-phasing vector is applied to reduce a peak to average power ratio (PAPR) of the radio signal.

7. The method of claim 1, wherein the co-phasing vector comprises a number of demodulation reference signal (DMRS) coefficients.

8. A user equipment (UE) comprising:
a configuration circuit that obtains a set of resource blocks for an uplink channel by a user equipment (UE) in an orthogonal frequency division multiplexing (OFDM) wireless communications network, wherein the set of resource blocks is distributed along frequency domain to occupy a predefined percentage of an entire channel bandwidth;
an OFDM circuit that applies a co-phasing vector comprising a set of co-phasing terms, wherein each co-phasing term of the co-phasing vector is applied to a corresponding resource block of the set of resource blocks; and
a radio frequency (RF) transmitter that transmits a radio signal containing uplink control information over the PUCCH applied with the co-phasing vector.

9. The UE of claim 8, wherein the uplink channel is a Physical Uplink Control Channel (PUCCH), wherein the PUCCH resource comprises one physical resource block (PRB) repeated every M PRBs along frequency domain.

10. The UE of claim 8, wherein the uplink channel is a Physical Uplink Control Channel (PUCCH), wherein the set of resource blocks comprises a number of consecutive physical resource blocks (PRBs) spread along frequency domain.

11. The UE of claim 8, wherein the uplink channel is a Physical Uplink Control Channel (PUCCH), wherein the set of resource blocks is uniformly allocated in the entire bandwidth, and wherein each physical resource block (PRB) is spread along frequency domain.

12. The UE of claim 8, wherein the uplink channel is a Physical Uplink Shared Channel (PUSCH), and wherein the PUSCH resources comprises interleaved physical resource blocks (PRBs).

13. The UE of claim 8, wherein the co-phasing vector is applied to reduce a peak to average power ratio (PAPR) of the radio signal.

14. The UE of claim 8, wherein the co-phasing vector comprises a number of demodulation reference signal (DMRS) coefficients.

15. A method comprising:
allocating a first set of resource blocks to a first user equipment (UE) by a base station in an orthogonal frequency division multiplexing (OFDM) wireless communications network;
allocating a second set of resource blocks to a second UE by the base station, wherein the first and the second sets of resource blocks comprise interleaved PRBs forming interlaces along frequency domain, wherein each interlace occupies a predefined percentage of an entire channel bandwidth; and
simultaneously scheduling the first UE and the second UE for uplink transmission over the first set of resource blocks and the second set of resource blocks respectively.

16. The method of claim 15, wherein the first and the second set of resource blocks form a first and a second Physical Uplink Control Channels (PUCCHs).

17. The method of claim 15, wherein the first and the second set of resource blocks form a first and a second Physical Uplink Shared Channels (PUSCHs).

18. The method of claim 15, wherein the first set of resource blocks is applied with a first co-phasing vector for uplink transmission by the first UE, wherein the second set of resource blocks is applied with a second co-phasing vector for uplink transmission by the second UE.

19. The method of claim 18, wherein each co-phasing vector comprises a set of co-phasing terms, wherein each co-phasing term is applied to a corresponding resource block of each set of resource blocks.

20. The method of claim 18, wherein each co-phasing vector comprises a set of demodulate reference signal (DMRS) coefficients.
